(19) United States
(12) Patent Application Publication
(10) Pub. No.: US 2022/0155424 A1
(43) Pub. Date: May 19, 2022

(54) LIDAR SENSOR FOR OPTICALLY DETECTING A FIELD OF VIEW AND METHOD FOR ACTIVATING A LIDAR SENSOR

(71) Applicant: Robert Bosch GmbH, Stuttgart (DE)

(72) Inventors: Alf Neustadt, Stuttgart (DE); Alexander Greiner, Reichenbach (DE); Siegwart Bogatscher, Leonberg (DE)

(21) Appl. No.: 17/594,194

(22) PCT Filed: Mar. 19, 2020
(86) PCT No.: PCT/EP2020/057613

§ 371 Date: Oct. 6, 2021

(30) Foreign Application Priority Data
Apr. 11, 2019 (DE) 10 2019 205 243.6

(51) Int. Cl. G01S 7/481; G01S 17/931

(52) U.S. Cl. CPC G01S 7/4817; G01S 7/4815; G01S 17/931

(57) ABSTRACT

A LIDAR sensor for optically detecting a field of view. The LIDAR sensor includes an emitting unit including at least one light source for generating/outputting primary light into a first angle range of the field of view; a deflection unit for deflecting primary light into a second angle range; and a receiving unit. The emitting unit outputs the primary light as a first transmission beam including two edge rays and as at least one second transmission beam including two edge rays into at least two partial ranges of the first angle range. The emitting unit outputs the first transmission beam so that its first edge ray is incident on a first edge area of a surface of the deflection unit, and outputs the second transmission beam so that its first edge ray is incident on a second edge area opposite to the first edge area.

### FIELD

The present invention relates to a LIDAR sensor for optically detecting a field of view and a method for activating a LIDAR sensor.

### BACKGROUND INFORMATION

LIDAR sensors are used, among other things, in driver assistance systems for motor vehicles for detecting the traffic surroundings, for example, for locating preceding vehicles or other obstacles/objects.

Conventional LIDAR sensors often use a rotatable and/or pivotable deflection unit, for example a mirror, to deflect emitted primary light and received secondary light in one dimension. The extension of the field of view in an angle range may be predefined here, for example, by a scanning direction of a rotatable mirror. If the LIDAR sensor is situated in or at a motor vehicle, for example, the angle range in the azimuth may be predefined by the scanning direction of the rotatable mirror. The extension of the field of view in an angle range orthogonal to this angle range, for example, the angle range in elevation, may be predefined on the basis of the size of a housing of the LIDAR sensor, the mirror size, and/or the size of the beam diameter of the primary light.

### SUMMARY

The present invention is directed to a LIDAR sensor for optically detecting a field of view. In accordance with an example embodiment of the present invention, the LIDAR sensor includes an emitting unit including at least one light source for generating and emitting primary light in a first angle range of the field of view; a deflection unit rotatable and/or pivotable around a rotational axis for deflecting primary light incident on the deflection unit in a second angle range of the field of view; and a receiving unit including at least one detector unit for receiving secondary light which was reflected and/or scattered by an object in the field of view. The first angle range is extended here in a plane situated in parallel to the rotational axis of the deflection unit. The emitting unit is designed to output the primary light as a first transmission beam including two edge rays and as at least one second transmission beam including two edge rays in at least two partial ranges of the first angle range. The emitting unit is furthermore designed to emit the first transmission beam in such a way that the first edge ray of the first transmission beam is incident on a first edge area of a surface of the deflection unit; and to emit at least one second transmission beam in such a way that the first edge ray of this second transmission beam is incident on a second edge area of the surface of the deflection unit opposite to the first edge area.

With the aid of a LIDAR sensor, a distance between the LIDAR sensor and an object in the field of view of the LIDAR sensor may be determined directly or indirectly on the basis of a signal time of flight (TOF). With the aid of a LIDAR sensor, a distance between the LIDAR sensor and an object in the field of view of the LIDAR sensor may be determined, for example, on the basis of a frequency-modulated continuous wave (FMCW).

In accordance with an example embodiment of the present invention, the light source of the emitting unit may be designed as at least one laser unit. The field of view of the LIDAR sensor may be scanned with the aid of the output primary light. The extension of the field of view may be predefined here by the first angle range and the second angle range, and by the range of the primary light. The primary light may be output and received again in different scanning angles of the field of view. Subsequently, a surroundings image may be derived from these angle-dependent individual measurements. The primary light is emitted at different scanning angles of the second angle range with the aid of the rotatable and/or pivotable deflection unit.

The LIDAR sensor optionally includes at least one evaluation unit. The received secondary light may be evaluated with the aid of the evaluation unit. The result of the evaluation may be used, for example, for a driver assistance function of a vehicle. The result of the evaluation may be used, for example, for a control of an autonomously driving vehicle. The LIDAR sensor may be designed in particular for use in an at least semi-autonomously driving vehicle. Semi-autonomous or autonomous driving of vehicles on expressways and/or in city traffic may be implemented using the LIDAR sensor.

The deflection unit may be a mirror rotatable and/or pivotable around a rotational axis. The deflection unit may be designed as a three-dimensional body. The surface of the deflection unit on which the first transmission beam is incident may be designed as a lateral surface of the deflection unit. The surface of the deflection unit on which the second transmission beam is incident may be designed as a lateral surface of the deflection unit. The first edge area of the surface of the deflection unit may be the first edge area of a lateral surface of the deflection unit. The first edge area may be situated, for example, in the area of the surface which is situated in the vicinity of a cover surface of the deflection unit. The second edge area of the surface of the deflection unit may be the second edge area of a lateral surface of the deflection unit. The second edge area may be situated, for example, in the area of the surface which is situated in the vicinity of a base surface of the deflection unit.

An advantage of the present invention is that the field of view of the LIDAR sensor may be enlarged. In particular, the field of view may be enlarged along the first angle range. In that the first edge ray of the first transmission beam is incident on a first edge area of a surface of the deflection unit and the first edge ray of the second transmission beam is incident on a second edge area of the surface of the deflection unit opposite to the first edge area, vignetting may be reduced or avoided. Vignetting is to be understood here as shading of output primary light and/or received secondary light by an edge of a housing of the LIDAR sensor. The generated primary light may be output in the first angle range over an entire length of an exit window of the LIDAR sensor. The beam diameter of the generated primary light may be enlarged to the entire length of the exit window. Hardly any to no generated primary light is lost at the edge of the housing upon output into the first angle range. In particular, the ocular safety of the LIDAR sensor may be improved in a middle range of the first angle range of the field of view. Primary light may be output in a middle range of the first angle range of the field of view with increased power and the range may thus be extended.

A range of the primary light for the at least two partial ranges of the first angle range may be settable separately in each case in particular.

The overall volume of the LIDAR sensor may be reduced. This may be implemented by enlarging the beam diameter of the output primary light while increasing the emitted power of the primary light at the same time.

In one advantageous embodiment of the present invention, it is provided that the emitting unit is furthermore designed to output the first transmission beam in such a way that the second edge ray of the first transmission beam is incident on a middle area of the surface of the deflection unit, and to output the at least one second transmission beam in such a way that the second edge ray of this second transmission beam is incident on a middle area of the surface of the deflection unit.

An advantage of this example embodiment is that the generated primary light may be output in the first angle range over an entire length of an exit window of the LIDAR sensor. The beam diameter of the generated primary light may be enlarged to the entire length of the exit window. The primary light may be output in the form of a line. This line may be designed in such a way that it extends over an entire length of an exit window of the LIDAR sensor.

In one advantageous embodiment of the present invention, it is provided that the first edge ray of the first transmission beam and the first edge ray of the second transmission beam are incident orthogonally to the rotational axis on the surface of the deflection unit.

An advantage of this embodiment is that vignetting may be avoided even more reliably. No generated primary light is lost at the edge of the housing upon output into the first angle range.

In one advantageous embodiment of the present invention, it is provided that the LIDAR sensor furthermore includes at least one first redirection mirror for redirecting primary light emitted by the emitting unit onto the deflection unit and/or for redirecting secondary light incident on the deflection unit onto the at least one detector unit.

An advantage of this embodiment is that a beam path of the primary light and a beam path of the secondary light may be brought into one axis. The size of the deflection unit may be reduced in this way.

In one advantageous embodiment of the present invention, it is provided that the at least one light source is designed to output a first part of the primary light as at least one transmission beam in a first partial range of the first angle range, and the emitting unit furthermore including at least one semi-reflecting mirror and at least one second redirection mirror; and the semi-reflecting mirror and the second redirection mirror being designed to output at least one second part of the primary light output by the light source in at least one second partial range of the first angle range.

An advantage of this embodiment is that one light source is sufficient for emitting the at least two transmission beam in the at least two partial ranges of the first angle range. The LIDAR sensor may thus be implemented more cost-effectively.

In another advantageous embodiment of the present invention, it is provided that the emitting unit includes at least two light sources. The at least two light sources may be designed here, for example, as laser bars.

An advantage of this embodiment is that additional optical elements, for example, a semi-reflecting mirror or a second redirection mirror, may be avoided. The overall volume of the LIDAR sensor may be reduced.

In another advantageous embodiment of the present invention, it is provided that a number of the light sources of the emitting unit corresponds to a number of the partial ranges of the first angle range. The light sources may be designed here, for example, as laser bars.

An advantage of this embodiment is that a voltage at the light sources may be reduced in each case by a factor which corresponds to the number of the light sources. A power consumption of the light sources may thus be reduced in total by this factor. Alternatively, a total power of the light sources may be increased by a first predefined factor while maintaining the power consumption. This first predefined factor may result from the square root of the number of the light sources. This may result in increasing the range of the primary light by a second predefined factor. The second predefined factor may result from the square root of the square root of the number of the light sources.

The present invention is furthermore directed to a method for activating a LIDAR sensor for optically detecting a field of view. In accordance with an example embodiment of the present invention, the method includes the steps of generating and outputting primary light in a first angle range of the field of view with the aid of an emitting unit; deflecting, with the aid of a deflection unit rotatable and/or pivotable around a rotational axis, primary light incident on the deflection unit in a second angle range of the field of view; and receiving secondary light which was reflected and/or scattered in the field of view by an object with the aid of a receiving unit. The first angle range is extended in a plane situated in parallel to the rotational axis of the deflection unit. The primary light is output as a first transmission beam including two edge rays and as at least one second transmission beam including two edge rays in at least two partial ranges of the first angle range with the aid of the emitting unit. With the aid of the emitting unit, the first transmission beam is output in such a way that the first edge ray of the first transmission beam is incident on the first edge area of a surface of the deflection unit; and at least one second transmission beam being output in such a way that the first edge ray of this second transmission beam is incident on an edge area of the surface of the deflection unit opposite to the first edge area.

In one advantageous embodiment of the present invention, it is provided that with the aid of the emitting unit, the first transmission beam is furthermore output in such a way that the second edge area of the first transmission beam is incident on a middle area of the surface of the deflection unit; and the at least one second transmission beam being output in such a way that the second edge ray of this second transmission beam is incident on a middle area of the surface of the deflection unit.

### BRIEF DESCRIPTION OF THE DRAWINGS

Exemplary embodiments of the present invention are explained in greater detail hereinafter on the basis of the figures. Identical reference numerals in the figures identify identical or identically acting elements.

FIG. 1 shows a side view of a first exemplary embodiment of a LIDAR sensor, in accordance with the present invention.

FIG. 2 shows a side view of a second exemplary embodiment of a LIDAR sensor, in accordance with the present invention.

FIG. 3 shows a side view of a third exemplary embodiment of a LIDAR sensor, in accordance with the present invention.

FIG. 4 shows a side view of a fourth exemplary embodiment of a LIDAR sensor, in accordance with the present invention.

FIG. 5 shows a top view of an exemplary embodiment of a LIDAR sensor, in accordance with the present invention.

FIG. 6 shows an exemplary embodiment of a method according to the present invention.

### DETAILED DESCRIPTION OF EXAMPLE EMBODIMENTS

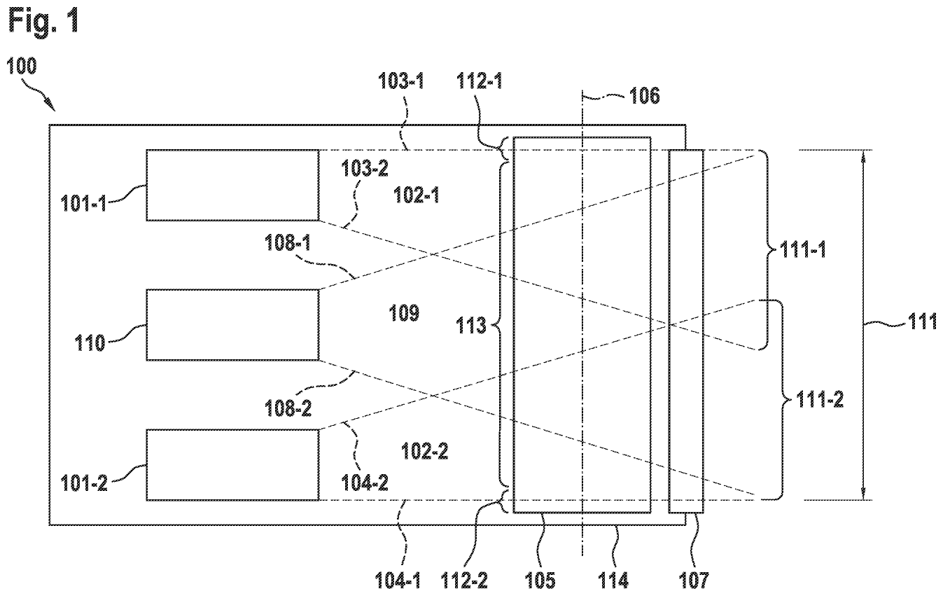

FIGS. 1 through 4 show various exemplary embodiments of a LIDAR sensor 100. FIGS. 1 through 4 show by way of example the output of two pencils of beams in each case in each of two partial ranges of the first angle range. However, more than two pencils of beams may also be output in more than two partial ranges of the first angle range. Furthermore, FIGS. 1 through 5 each show an unfolded beam path, which was brought into one plane, for better comprehension of the present invention.

FIG. 1 shows by way of example a side view of a first exemplary embodiment of a LIDAR sensor 100 for optically detecting a field of view. LIDAR sensor 100 includes an emitting unit including light sources 101-1 and 101-2 for generating and outputting primary light in a first angle range 111 of the field of view. LIDAR sensor 100 furthermore includes a deflection unit 105 rotatable and/or pivotable around a rotational axis 106 for deflecting primary light incident on deflection unit 105 in a second angle range of the field of view of LIDAR sensor 100. First angle range 111 is extended in a plane situated in parallel to rotational axis 106 of deflection unit 105.

Light source 101-1 generates primary light and outputs it as a first transmission beam 102-1 in a first partial range 111-1 of first angle range 111. First transmission beam 102-1 includes the two edge rays 103-1 and 103-2. The emitting unit is designed to output first transmission beam 102-1 in such a way that first edge ray 103-1 of first transmission beam 102-1 is incident on a first edge area 112-1 of a surface of a deflection unit 105. Light source 101-1 is designed to output first transmission beam 102-1 in such a way that first edge ray 103-1 of first transmission beam 102-1 is incident on a first edge area 112-1 of a surface of a deflection unit 105. As shown in FIG. 1, first edge ray 103-1 of first transmission beam 102-1 is incident in particular orthogonally to rotational axis 106 on the surface of deflection unit 105. The emitting unit is furthermore designed to output first transmission beam 102-1 in such a way that second edge ray 103-2 of first transmission beam 102-1 is incident on a middle area 113 of the surface of deflection unit 105. Light source 101-1 is furthermore designed to output first transmission beam 102-1 in such a way that second edge ray 103-2 of first transmission beam 102-1 is incident on a middle area 113 of the surface of deflection unit 105. Second edge ray 103-2 is incident here in particular at an angle different from 90° in relation to rotational axis 106 on deflection unit 105.

Light source 101-2 generates primary light and outputs it as a second transmission beam 102-2 in a second partial range 111-2 of first angle range 111. Second transmission beam 102-2 includes second edge rays 104-1 and 104-2. The emitting unit is designed to emit second transmission beam 102-2 in such a way that first edge ray 104-1 of second transmission beam 102-2 is incident on a second edge area 112-2 of a surface of a deflection unit 105. Second edge area 112-2 is opposite to first edge area 112-1 here on the surface of deflection unit 105. Light source 101-2 is designed to output second transmission beam 102-2 in such a way that first edge ray 104-1 of second transmission beam 102-2 is incident on a second edge area 112-2 of a surface of a deflection unit 105. As shown in FIG. 1, first edge ray 104-1 of second transmission beam 102-2 is incident in particular orthogonally to rotational axis 106 on the surface of deflection unit 105. The emitting unit is furthermore designed to output second transmission beam 102-2 in such a way that second edge ray 104-2 of second transmission beam 102-2 is incident on a middle area 113 of the surface of deflection unit 105. Light source 101-2 is furthermore designed to output second transmission beam 102-2 in such a way that second edge ray 104-2 of second transmission beam 102-2 is incident on a middle area 113 of the surface of deflection unit 105. Second edge ray 104-2 is incident here in particular at an angle different from 90° in relation to rotational axis 106 on deflection unit 105.

The number of light sources of LIDAR sensor 100 shown in FIG. 1 is two. This corresponds to the number of partial ranges (111-1 and 111-2) of first angle range 111, which is also two. However, more than two pencils of beams may also be output into more than two partial ranges of the first angle range. For this purpose, LIDAR sensor 100 may include, for example, one or multiple further light source(s). One such further light source may be situated between light sources 101-1 and 101-2. The edge rays of the light beam output by a further light source may be incident in this case at an angle different from 90° in relation to rotational axis 106 on deflection unit 105.

The generated primary light may be output in first angle range 111 over an entire length of an exit window 107 of LIDAR sensor 100. Exact window 107 is situated in a housing 114. The generated primary light may be output in the form of a line. The output primary light may be reflected and/or scattered by an object in the field of view of LIDAR sensor 100. The reflected and/or scattered primary light may be received as secondary light by a receiving unit 110 of LIDAR sensor 100. Receiving unit 110 is situated between light sources 101-1 and 101-2. Receiving unit 110 includes at least one detector unit (not shown in FIG. 1) for this purpose. Secondary light may be received as a reception beam 109. Reception beam 109 includes edge rays 108-1 and 108-2. Receiving unit 110 is preferably designed so that it may receive secondary light from entire first angle range 111.

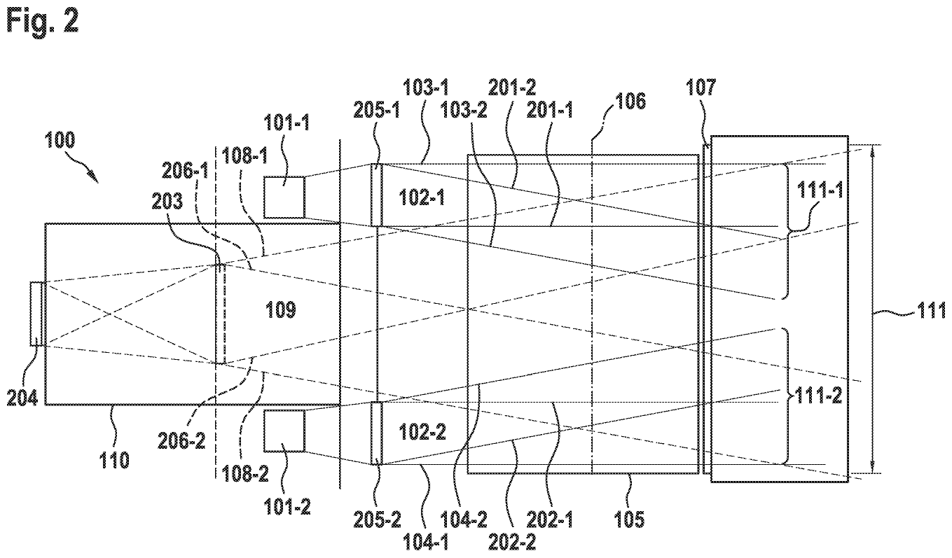

FIG. 2 shows by way of example a side view of a second exemplary embodiment of a LIDAR sensor 100. LIDAR sensor 100 from FIG. 2 essentially corresponds here to the LIDAR sensor from FIG. 1. Accordingly, identical or identically acting elements are provided with identical reference numerals. However, FIG. 2 shows a more detailed illustration, in which individual beams of the first transmission beam, the second transmission beam, and the reception beam are also shown. Primary light is thus also generated by light source 101-1 in FIG. 2 and this light is output as a first transmission beam 102-1 into a first partial range 111-1 of first angle range 111. The primary light initially passes through an optical element 205-1. Optical element 205-1 may be designed as an optical lens. First transmission beam 102-1 again includes first edge ray 103-1, which includes features as described in FIG. 1. First transmission beam 102-1 again includes second edge ray 103-2, which includes features as described in FIG. 1. Furthermore, individual beams 201-1 and 201-2 of first transmission beam 102-1 are shown. Individual beam 201-1 is in particular incident orthogonally to rotational axis 106 on the surface of deflection unit 105. Individual beam 201-2 is in particular incident at an angle different from 90° to rotational axis 106 on deflection unit 105.

Primary light is also generated by light source 101-2 and this is output as a second transmission beam 102-2 into a second partial range 111-2 of first angle range 111. The primary light initially passes through an optical element 205-2. Optical element 205-2 may be designed as an optical lens. Second transmission beam 102-2 again includes first edge ray 104-1, which includes features as described in FIG. 1. Second transmission beam 102-2 again includes second edge ray 104-2, which includes features as described in FIG. 1. Furthermore, individual beams 202-1 and 202-2 of second transmission beam 102-2 are shown. Individual beam 202-1 is in particular incident orthogonally to rotational axis 106 on the surface of deflection unit 105. Individual beam 202-2 is in particular incident at an angle different from 90° in relation to rotational axis 106 on deflection unit 105.

Furthermore, receiving unit 110 is shown in more detail. Detector unit 204 of receiving unit 110 is shown. Reception beam 109 is guided with the aid of optical element 203 onto detector unit 204. Optical element 203 may be designed as an optical lens. Further individual beams 206-1 and 206-2 are also additionally shown for reception beam 109.

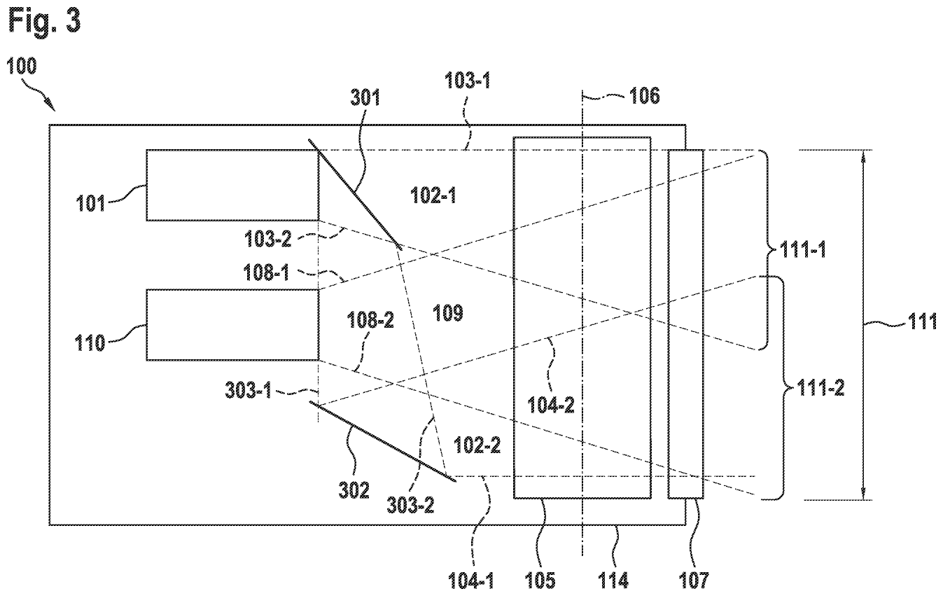

FIG. 3 shows by way of example a side view of a third exemplary embodiment of a LIDAR sensor 100. This LIDAR sensor 100 is similar here to LIDAR sensor 100 shown in FIG. 1. Identical or identically acting elements are provided with identical reference numerals. In contrast to LIDAR sensor 100 from FIG. 1, the emitting unit of LIDAR sensor 100 shown in FIG. 3 includes precisely one light source 101. Light source 101 is designed to output a first part of the primary light as at least one transmission beam 102-1 into a first partial range 111-1 of first angle range 111. The emitting unit furthermore includes a semi-reflecting mirror 301. A second part of the primary light output by light source 101 is redirected with the aid of semi-reflecting mirror 301 onto a redirection mirror 302. This is illustrated by edge rays 303-1 and 303-2. From redirection mirror 302, the second part of the primary light is output into second partial range 111-2 of first angle range 111. Semi-reflecting mirror 301 and second redirection mirror 302 are thus designed to output a second part of the primary light output by light source 101 into second partial range 111-2 of first angle range 111.

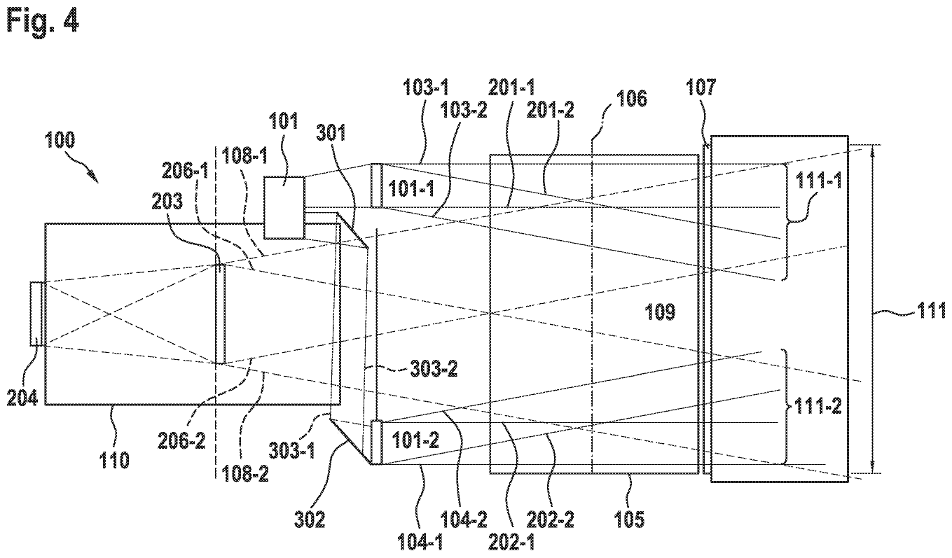

FIG. 4 shows by way of example a side view of a fourth exemplary embodiment of a LIDAR sensor 100. LIDAR sensor 100 from FIG. 4 essentially corresponds here to the LIDAR sensor from FIG. 3. Accordingly, identical or identically acting elements are provided with identical reference numerals. FIG. 4 again shows a more detailed illustration than FIG. 3, however, in which individual beams of the first transmission beam, the second transmission beam, and the reception beam are also shown. Reference is made to the explanations of FIG. 2 with respect to the explanation of these individual beams and the more detailed illustration of receiving unit 110. The features described there apply similarly to LIDAR sensor 100 from FIG. 4.

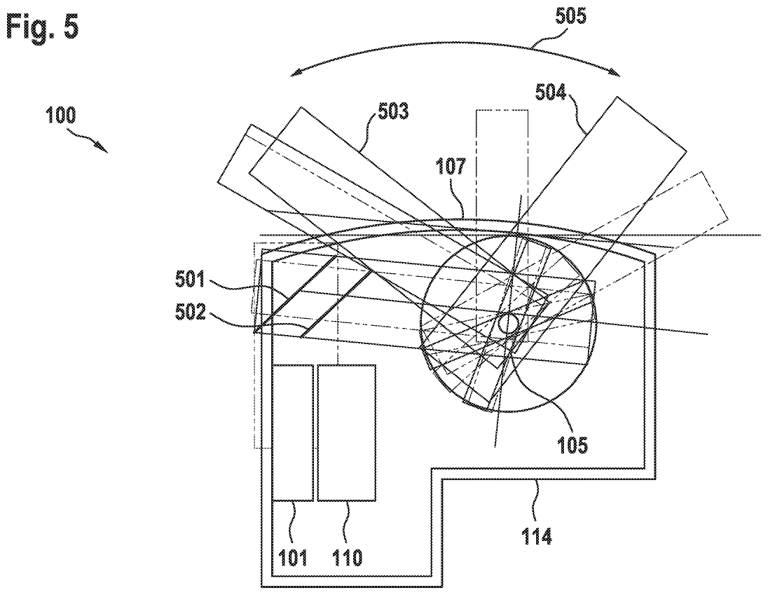

FIG. 5 shows by way of example a top view of an exemplary embodiment of a LIDAR sensor 100. Only one light source 101, as in the exemplary embodiments from FIGS. 4 and 5, is shown by way of example. The top view shown here also corresponds, however, to a top view of the exemplary embodiments of LIDAR sensor 100 according to FIGS. 1 and 2. In this case, for example, a first light source 101-1 would be apparent instead of light source 101 shown in FIG. 5. Light source 101-2 would be situated in the plane of the drawing behind light source 101-1 and would thus be concealed thereby.

LIDAR sensor 100 in FIG. 5 furthermore includes the two first redirection mirrors 501 and 502. LIDAR sensors 100 from FIGS. 1 through 4 may optionally include such a first redirection mirror; it is not shown in FIGS. 1 through 4. First redirection mirrors 501 and 502 differ from second redirection mirror 302 of the emitting unit shown in FIGS. 3 and 4. One first redirection mirror 501 is designed to redirect the primary light emitted by emitting unit onto deflection unit 105. Deflection unit 105 is designed to deflect the incident primary light into a second angle range 505 of the field of view. The incident primary light may be deflected here into two different partial ranges of second angle range 505. Partial ranges 503, 504 are identified as examples. Other first redirection mirror 502 is designed to redirect secondary light incident on deflection unit 105 onto the at least one detector unit of receiving unit 110. With the aid of first redirection mirrors 501 and 502, a beam path of the primary light and a beam path of the secondary light may be brought into one axis.

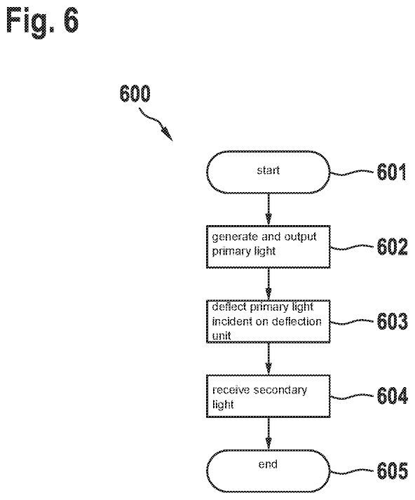

FIG. 6 shows an exemplary embodiment of a method 600 according to the present invention for activating a LIDAR sensor for optically detecting a field of view. Method 600 starts in step 601. In step 602, primary light is generated with the aid of an emitting unit and output into a first angle range of the field of view. The first angle range is extended in a plane situated in parallel to a rotational axis of a deflection unit rotatable and/or pivotable around the rotational axis. The primary light is output as a first transmission beam including two edge rays and as at least one second transmission beam including two edge rays into at least two partial ranges of the first angle range with the aid of the emitting unit. With the aid of the emitting unit, the first transmission beam is output here in such a way that the first edge ray of the first transmission beam is incident on a first edge area of a surface of the deflection unit; and at least one second transmission beam being output in such a way that the first edge ray of the second transmission beam is incident on a second edge area of the surface of the deflection unit opposite to the first edge area. In step 603, primary light incident on the deflection unit is deflected into a second angle range of the field of view with the aid of the deflection unit rotatable and/or pivotable around the rotational axis. In step 604, secondary light which was reflected and/or scattered by an object in the field of view is received with the aid of a receiving unit. The method ends in step 605.

In one advantageous embodiment, the first transmission beam is output with the aid of the emitting unit in such a way that the second edge ray of the first transmission beam is incident on a middle area of the surface of the deflection unit; and the at least one second transmission beam being output in such a way that the second edge ray of this second transmission beam is incident on a middle area of the surface of the deflection unit.

1-9. (canceled)

10. A LIDAR sensor for optically detecting a field of view, comprising:
an emitting unit including at least one light source configured to generate and output primary light into a first angle range of the field of view;
a deflection unit rotatable and/or pivotable around a rotational axis configured to deflect the primary light incident on the deflection unit into a second angle range of the field of view; and
a receiving unit including at least one detector unit configured to receive secondary light, which was reflected and/or scattered by an object in the field of view;
wherein:
the first angle range extends in a plane situated in parallel to the rotational axis of the deflection unit;
the emitting unit is configured to output the primary light as a first transmission beam including two edge rays, and as at least one second transmission beam including two edge rays, into at least two partial ranges of the first angle range; and
the emitting unit is configured to output the first transmission beam in such a way that a first edge ray of the two edge rays of the first transmission beam is incident on a first edge area of a surface of the deflection unit, and to output the at least one second transmission beam in such a way that a first edge ray of the two edge rays of the second transmission beam is incident on a second edge area of the surface of the deflection unit opposite to the first edge area.

11. The LIDAR sensor as recited in claim 10, wherein the emitting unit is further configured to output the first transmission beam in such a way that a second edge ray of the two edges rays of the first transmission beam is incident on a middle area of the surface of the deflection unit, and to output the at least one second transmission beam in such a way that a second edge ray of the two edge rays of the second transmission beam is incident on the middle area of the surface of the deflection unit.

12. The LIDAR sensor as recited in claim 10, wherein the first edge ray of the first transmission beam and the first edge ray of the second transmission beam are incident on the surface of the deflection unit orthogonally to the rotational axis.

13. The LIDAR sensor as recited in claim 10, further comprising:
at least one first redirection mirror configured to redirect the primary light emitted by the emitting unit onto the deflection unit and/or to redirect the secondary light incident on the deflection unit onto the at least one detector unit.

14. The LIDAR sensor as recited in claim 10, wherein the at least one light source is configured to output a first part of the primary light as at least one transmission beam into a first partial range of the first angle range, and the emitting unit further includes at least one first semi-reflecting mirror and at least one second redirection mirror, and the semi-reflecting mirror and the second redirection mirror are configured to output at least a second part of the primary light output by the light source into at least one second partial range of the first angle range.

15. The LIDAR sensor as recited in claim 10, wherein the emitting unit includes at least two light sources.

16. The LIDAR sensor as recited in claim 15, wherein a number of the light sources of the emitting unit corresponds to a number of the partial ranges of the first angle range.

17. A method for activating a LIDAR sensor for optically detecting a field of view comprising the following steps:
generating and outputting primary light into a first angle range of the field of view using an emitting unit;
deflecting, using a deflection unit rotatable and/or pivotable around a rotational axis, the primary light incident on the deflection unit into a second angle range of the field of view; and
receiving secondary light which was reflected and/or scattered by an object in the field of view using a receiving unit;
wherein:
the first angle range being extended in a plane situated in parallel to the rotational axis of the deflection unit;
the primary light is output as a first transmission beam including two edge rays and as at least one second transmission beam including two edge rays, into at least two partial ranges of the first angle range using the emitting unit;
the first transmission beam is output using the emitting unit in such a way that a first edge ray of the two edge rays of the first transmission beam is incident on a first edge area of a surface of the deflection unit, and at least one second transmission beam is output in such a way that a first edge ray of the two edges rays of the second transmission beam is incident on a second edge area of the surface of the deflection unit opposite to the first edge area.

18. The method as recited in claim 17, wherein the first transmission beam is output using the emitting unit in such a way that a second edge ray of the two edges rays of the first transmission beam is incident on a middle area of the surface of the deflection unit, and the at least one second transmission beam is output in such a way that a second edge ray of the two edge rays of the second transmission beam is incident on the middle area of the surface of the deflection unit.
